(19) United States
(12) Patent Application Publication
(10) Pub. No.: US 2019/0242155 A1
(43) Pub. Date: Aug. 8, 2019

(54) SCREWLESS STRIKE DEVICE FOR LOCKS

(71) Applicant: BONAITI SERRATURE S.P.A., Calolziocorte, Lecco (IT)

(72) Inventor: Luigi BOLOGNESI, Laglio (IT)

(21) Appl. No.: 16/317,402

(22) PCT Filed: Jul. 13, 2017
(86) PCT No.: PCT/EP2017/067758

§ 371 Date: Jan. 11, 2019

(30) Foreign Application Priority Data
Jul. 14, 2016 (IT) 102016000073512

(51) Int. Cl. E05B 15/02; E05B 9/00; E05C 19/16

(52) U.S. Cl. CPC E05B 15/0205; E05Y 2900/132; E05C 19/163; E05B 9/002

(57) ABSTRACT

A screwless strike device for latch- or bolt-locks includes a box body of elongated shape, having a front cavity configured for engaging the latch or bolt of a lock, and a face plate that conforms to the box body. The box body is provided with one or more elastically yieldable locking arms, configured for locking the box body in a housing seat of a door frame or other support member. The face plate is provided with one or more rear pushing members, configured to be press-fitted between the locking arms and respective contrasting surfaces of the box body, to open the locking arms and push the locking arms against an inner surface of the housing seat of the box body.

### BACKGROUND OF THE INVENTION

The present invention refers to a strike device for latch locks, or bolt locks, in particular and not exclusively for locks with magnetic latches or bolts, of the type comprising a box body and a face plate configured with a cavity and respectively with an opening for engaging the latch or bolt of the lock, and configured for being locked in a corresponding housing seat, or another support element, by a screwless fixing system.

### PRIOR ART

Strike devices for locks normally consist of a variously configured flat plate with one or more cavities for engaging the bolt and/or the latch of a lock; the plate is further provided with holes for corresponding screws for fixing to the wooden frame of a door or another support element. The screws can be oriented orthogonally or tilted with respect to the strike plate, being visible with a scarcely pleasing result; there is further the possible risk that an incorrectly or partially tightened screw may accidentally come into contact with a person. Strike devices of the type mentioned are shown for example in U.S. Pat. No. 4,854,622, AT004700 and US 2016/069105.

Strike devices for locks have also been proposed, substantially comprising a face plate that is integral with a cup body, configured for permitting engagement with the latch and/or with the bolt of a lock. The cup body can be further provided with a cavity for receiving a magnet; examples of similar strike devices are shown in DE2921201, USD451700 and IT 1377400. In all these solutions, the strike device is always fixed to the frame of a door by screws, similarly to a conventional strike plate.

In order to overcome partially the problems indicated above, or to anchor the contrasting device to frames or supports of reduced thickness, it has been proposed to configure the cup body with suitably tilted internal or external holes for the fixing screws; examples of such strike plates are shown in U.S. Pat. Nos. 3,392,998, 4,186,954, US2008/0265590, EP2248968 and AU561724.

Although, according to these solutions, the fixing screws can be positioned inside the cup body, in practice the screws are not completely hidden and cannot be eliminated in any manner.

### OBJECTS OF THE INVENTION

There is accordingly the problem of finding a new and different solution for a strike device for locks, which is suitably configured to enable a door or another support element to be fixed into a housing seat of the wooden frame without using screws or special tools.

Within the scope of this problem there further exists the need to find a solution that does not require extremely precise processing of the housing seat and that at the same time enables possible machining gaps, slack and tolerances of the housing seat to be compensated, ensuring at the same time firm anchoring to the strike element.

The main object of the present invention is thus to propose a strike device for locks, of both mechanical and magnetic type, in which the use of fixing screws has been completely eliminated, with consequent constructional simplification, comparatively low costs, and improved visual appeal.

A further object of the invention is to provide a strike device for locks, devoid of fixing screws, the external aesthetic appearance of which can be easily varied, both before and during application thereof in the housing seat of a frame of a door or another support element.

A still further object is to provide a strike device for locks, configured in such a manner as to enable possible misalignments between the strike device and the latch or bolt of a lock to be compensated.

### SHORT DESCRIPTION OF THE INVENTION

The above can be achieved by a strike device for locks according to claim 1.

In particular, according to the invention, a strike device for locks is provided, comprising in combination:
a box body of elongated shape, having a peripheral wall and a front cavity configured for engaging a latch or a bolt of a lock, which extend according to a longitudinal axis;
a face plate that conforms to the box body; and
means for fixing the box body in a housing seat of a frame of a door or another support element,
characterised in that
the box body comprises one or more locking arms, which are elastically yieldable at at least one end, or at at least one side of the box body, in a condition spaced away from a respective contrast surface of the peripheral wall of the box body; and
wherein the face plate comprises at least one rear pushing member configured for a press-fit between the locking arm and a respective contrasting surface of the box body, to spread and press the locking arm against an inner surface of the housing seat of the box body.

Each rear pushing member of the face plate, acting as a divaricating member, the locking arms and the peripheral wall of the box body are configured with surfaces in reciprocal contact to flex or divaricating elastically the locking arms, reciprocally or with respect to the peripheral surface of the box body, to the inner shoulder surface of the housing seat.

The locking arms of the box body can be configured and oriented in any manner, for example in the longitudinal direction of the box body; further, they can be positioned at one or both the ends, or along at least one side of the box body.

Lastly, the locking arms can have a linear configuration, or an arched configuration that is suitable for exerting locking forces in both a longitudinal and transverse direction of the box body.

The elastically yieldable locking arms of the box body and the press-fitting of the divaricating pushing members of the face plate, in addition to enabling the strike device to be anchored firmly, also enable possible processing clearances and tolerances of the housing seat to be compensated.

### SHORT DESCRIPTION OF THE DRAWINGS

Some preferential embodiments of the strike device for locks according to the invention will be disclosed in greater detail here below, with reference to the drawings, in which:

FIG. 1 is a frontal perspective view of a first embodiment, with the box body and the face plate in a disassembled condition;

FIG. 2 is a perspective view of the rear side of the strike device of FIG. 1;

FIG. 3 is a perspective view of the strike device of FIG. 1, in an assembled condition;

FIG. 4 is a top plan view of the box body of FIG. 1;

FIG. 5 is a longitudinal section of the strike device of FIG. 4;

FIG. 6 is a section on a longitudinal plane, along the line 6-6 of FIG. 5;

FIG. 7 is a first enlarged detail of FIG. 6;

FIG. 8 is a second enlarged detail of FIG. 6;

FIG. 9 is a frontal perspective view of a second embodiment, in a disassembled condition;

FIG. 10 is a rear perspective view of the strike device of FIG. 9;

FIG. 11 is a side view of the strike device, in an assembled condition;

FIG. 12 is a longitudinal section of the strike device of FIG. 11, along the line 12-12 of FIG. 13;

FIG. 13 is a section on a longitudinal plane, along the line 13-13 of FIG. 12;

FIG. 14 is a frontal perspective view, in a disassembled condition, of a third embodiment;

FIG. 15 is a top plan view of the box body of the strike device of FIG. 14;

FIG. 16 is a rear view of the box body of FIG. 15;

FIG. 17 is a frontal perspective view, in a dismantled condition, of a fourth embodiment;

FIG. 18 is a top plan view of the box body of FIG. 17;

FIG. 19 is a rear view of the box body of FIG. 18;

FIG. 20 is a perspective view, in a dismantled condition, of a fifth embodiment;

FIG. 21 is a top plan view of the box body of FIG. 20;

FIG. 22 is a cross section along the line 22-22 of FIG. 21.

### DETAILED DESCRIPTION OF THE INVENTION

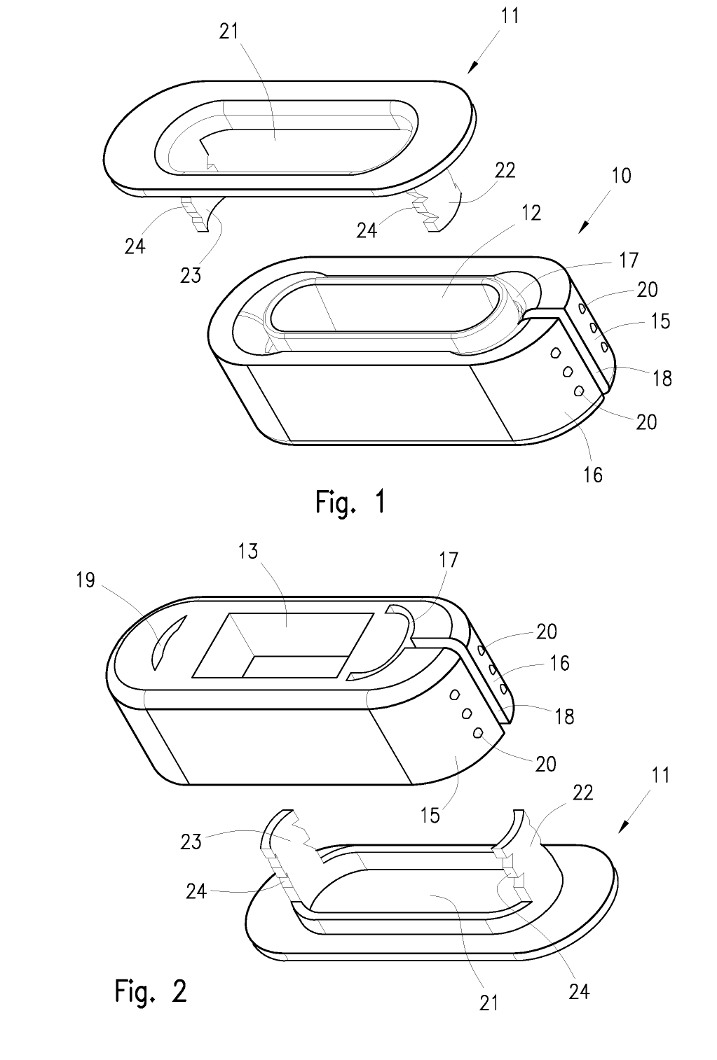

With reference to FIGS. 1 to 8, in greater detail the innovative features will be disclosed of a first embodiment of a strike device for locks according to the invention, characterised by a screwless fixing system, which is suitable both for locks with a latch or bolt of mechanical type, and for locks with a latch or bolt of magnetic type, which are not illustrated inasmuch as they are per se known and inasmuch do not form part of the present invention.

As shown in FIGS. 1 and 2, the strike device for locks comprises a box body 10, for example obtained by moulding plastics, and a face plate 11 made of any type of material.

The box body 10 has an elongated shape in a longitudinal direction, being provided with a peripheral surface and with rounded ends that conform to a housing seat obtained in the wooden frame of a door or another support element.

In particular, the box body 10 is provided with a first elongated cavity 12 opened frontally, which is suitable for engaging the bolt or the latch of a lock, which extends longitudinally between the two rounded ends of the box body 10.

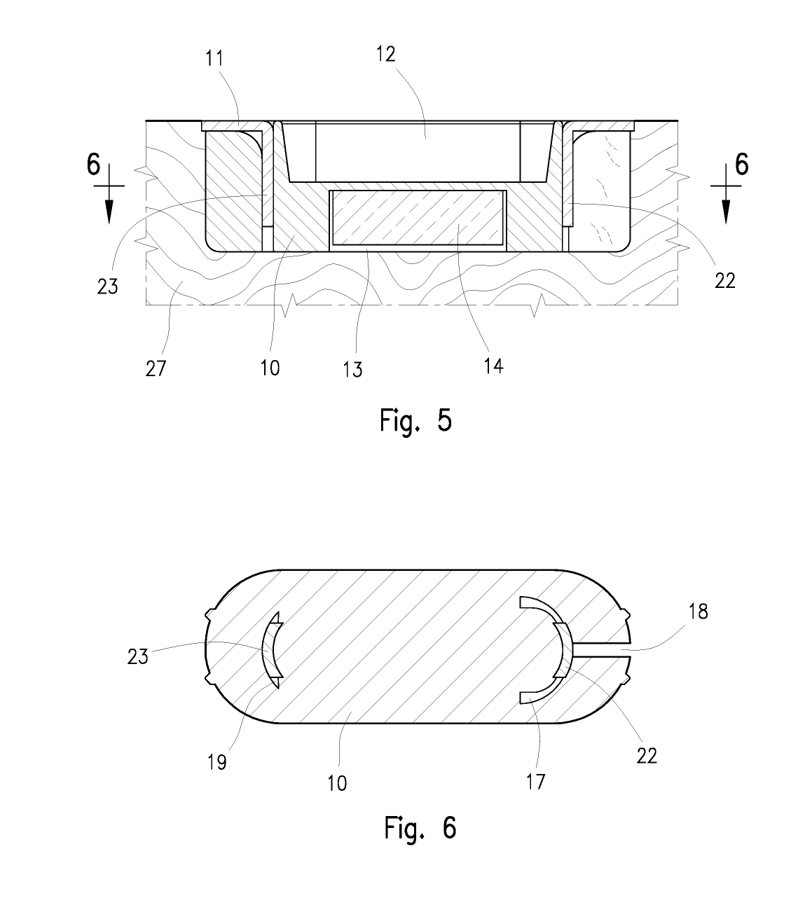

If the strike device has to be used with locks with magnetic latches or bolts, the box body 10 can be optionally provided with a second rear cavity 13 that is suitable for containing a permanent magnet 14, shown in the longitudinal section of FIG. 5.

Still with reference to FIGS. 1-8, according to this first embodiment, the box body 10 has two elastically yieldable locking arms 15, 16, that extend in a direction that is substantially longitudinal to a sole end; the locking arms 15 and 16 also have an arched configuration that conforms to the rounded ends of the box body 10.

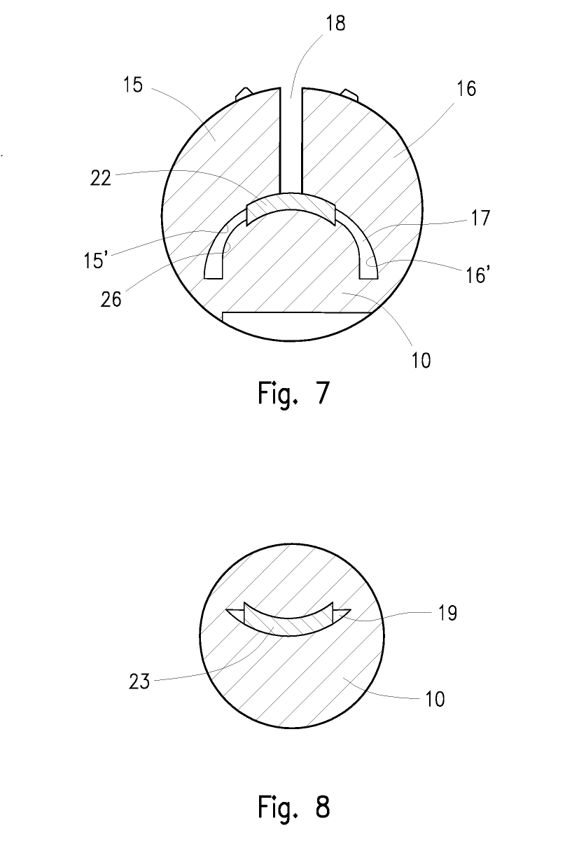

As shown in FIGS. 1, 2 and in the detail of FIG. 7, each arched locking arm 15, 16 protrudes in a condition that is spaced away from the peripheral surface of the box body 10, according to a first arched slit 17 in which a longitudinal slit 18 opens between facing surfaces of the two locking arms 15 and 16.

The box body 10 at the opposite end to that of the locking arms 15, 16 has a second arched slit 19, FIG. 2, for the reasons explained below.

Optionally, the two rounded ends of the box body 10, in particular the two locking arms 15, 16, can be configured with pointed members, toothing and/or ribs 20 that are suitable for penetrating or generating a strong friction force against an inner surface of a housing seat of the box body 10, when the two locking arms 15, 16 are divaricated elastically, both reciprocally and with respect to the peripheral wall of the body 10, after the box body 10 has been inserted into the suitable housing seat of the frame of a door or support element 27, and locked by the face plate 11.

In this regard, as shown in the views of FIG. 1, 2 and in the details of FIGS. 5, 7 and 8, the face plate 11 has a flat configuration and an elongated cavity 21 that conform to the elongated shape of the box body 10 and of the cavity 12 for the latch or bolt of the lock.

The face plate 11 is configured with members for divaricating the locking arms 15, 16 that, in the case shown, consist of two legs 22, 23 with the shape of a bent tile that extend behind the two ends of the cavity 21.

The two legs 22 and 23 have toothed side edges 24 that are intended to press-fit into the box body 10, in the assembled condition of the face plate, as shown in FIGS. 6-8.

More precisely, as shown in an assembled condition, the rear leg 22 is press-fitted into the arched slit 17, and coming into reciprocal contact with a contrasting surface 26 of the peripheral wall of the box body 10, respectively with inner contrasting surfaces 15′ and 16′ of the two locking arms 15, 16, FIG. 7, causes a divarication or a reciprocal opening of the arms, which are in this case pushed against a corresponding inner surface of the housing seat of the body 10, being firmly anchored by the pointed protrusions 20, ribs or the like, which tend to penetrate the wood or become anchored by friction.

According to this first solution, the other rear member 23 of the face plate 11 performs only a function of anchoring to the body 10, being simply press-fitted into the arched slit 19, as is shown in the detail of FIG. 8.

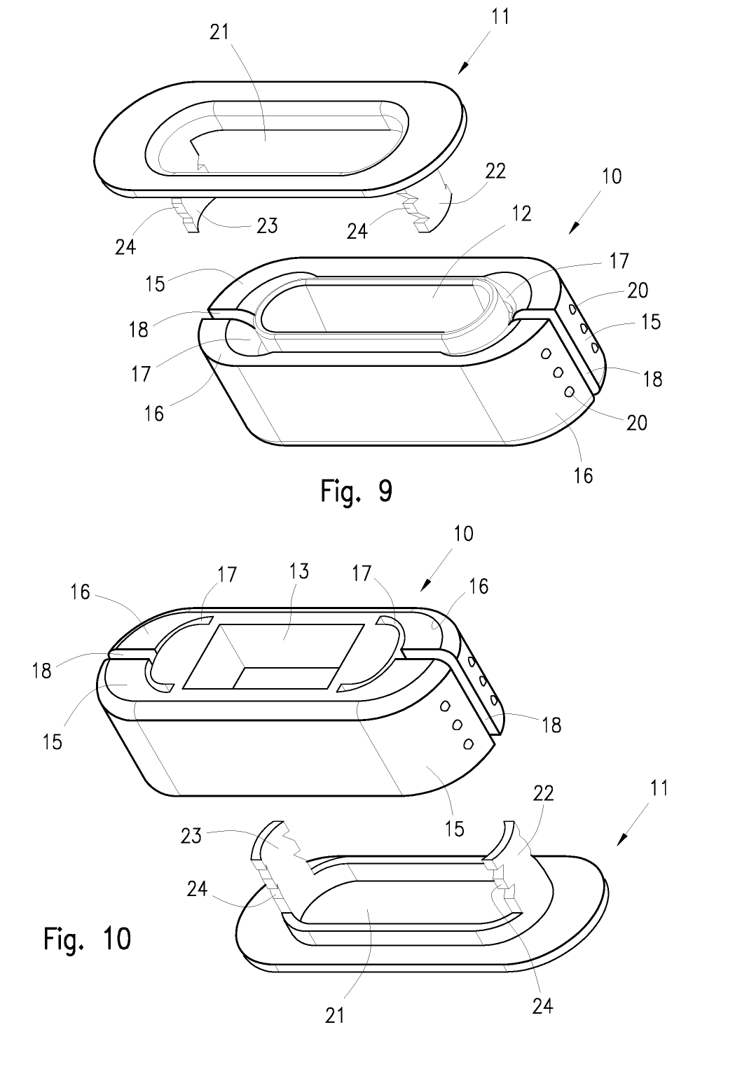

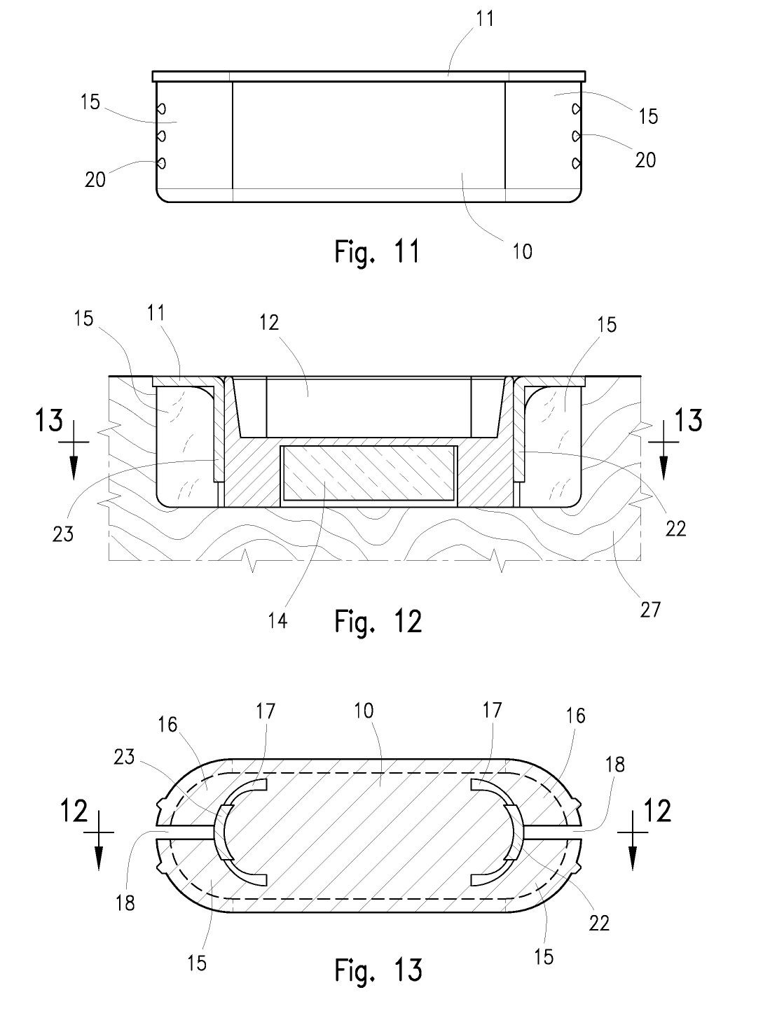

FIGS. 9 to 12 show a second solution that is in certain ways similar to that of the preceding figures; accordingly, in FIGS. 9 to 12 the same reference numbers have been used as in the preceding FIGS. 1 to 8, to indicate similar or equivalent parts.

This second solution differs from the preceding solution inasmuch as the box body 10 is conformed with two arched locking arms 15, 16, a corresponding arched slit 17 and a linear slit 18 at each end thereof; the face plate 11 of FIGS. 9-12 is on the other hand configured identically to the face plate 11 of the preceding embodiment.

Also in this case, in order to assemble the face plate 11 on the box body 10 and lock the latter after it has been inserted into a housing seat in the frame of a door or another support element, it suffices to push the two legs 22, 23 of the face plate 11 into the corresponding arched slits 17, to divaricate reciprocally the two locking arms 15, 16 at each end of the box body 10, locking the latter in the housing seat thereof, without the help of any fixing screw.

In this manner, not only is the entire strike device simplified constructionally, but assembly operations are facilitated significantly because it is no longer necessary to use screws and tools and it is also possible to compensate possible machining tolerances of the housing seat.

The total elimination of the fixing screws, in addition to simplifying the device constructionally, also enables the device to be applied easily to frames or support elements of reduced thickness.

As in the preceding embodiment of FIGS. 1-8, the rear legs 22, 23 of the face plate 11 are configured as bent tile-shaped toothed side edges 24; further, each rear leg 22, 23, the locking arms 15, 16 and the peripheral wall 26 of the box body 10, at the arched slits 17, have surfaces in reciprocal contact configured for flexing and pressing elastically the locking arms 15, 16 against a corresponding inner surface of a housing seat of the box body 10.

Lastly, as shown in FIGS. 10 and 12, also in this case the box body 10 can be provided with a rear cavity 13 for housing a permanent magnet 14, if the strike device is used with a lock of magnetic latch or bolt type. Again, the presence of pointed protrusions, of ribs or of toothing 20 on the outer surface of the locking arms 15, 16, facilitates anchoring of the box body 10 in the housing seat thereof.

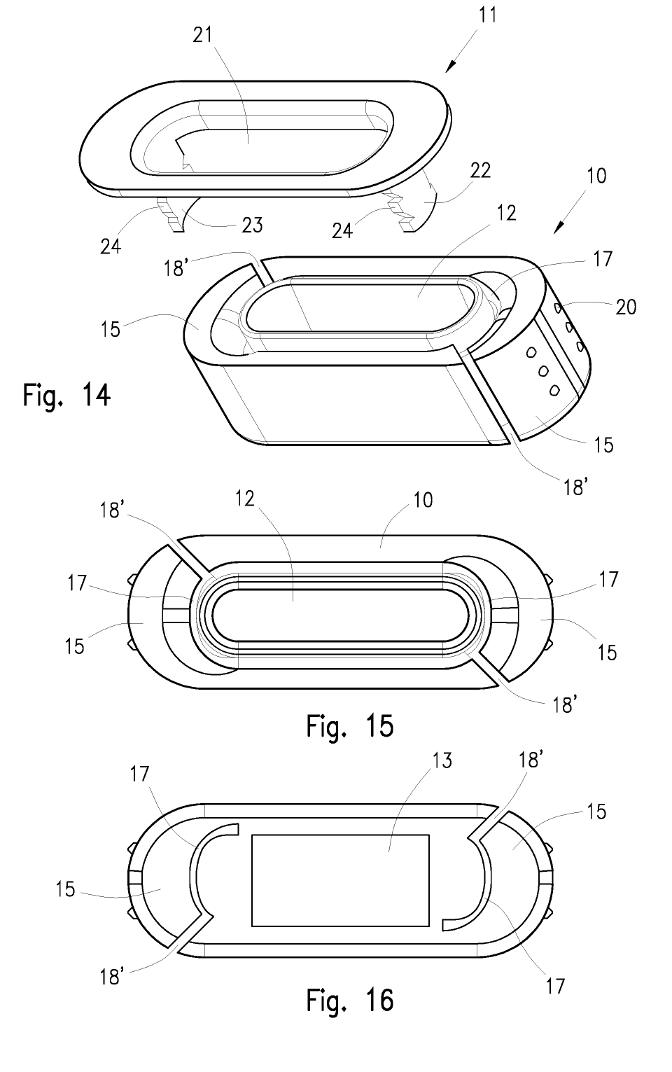

FIGS. 14, 15 and 16 show a third solution of a strike device for locks having all the general features of the present invention; thus also in FIGS. 14-16 the same reference numbers have been used as for the previous figures to indicate similar or equivalent parts.

The strike device for locks of both mechanical and magnetic type again comprises a box body 10 made of plastics and a face plate 11 made of any type of plastic, metal or a combination thereof.

Unlike the preceding cases, the box body 10 is configured with only one locking arm 15 of arched shape, at each end thereof, that extends in the longitudinal direction of the body 10, and along an arched slit 17 that again opens to the front and the rear on a side of the body 10 by a rectilinear slit 18′.

The two locking arms 15 are integral with the two sides opposite the body 10, to rotate and be divaricated in opposite directions when the rear legs 22, 23 of the face plate 11 are forced into the respective arched slits 17, as explained previously. Again, the box body 10 can be provided with a rear cavity 13 for housing a permanent magnet 14, and with pointed protrusions 20, ribs or toothing on the outer surface of the locking arms.

In the previously disclosed embodiments, the arched shape of the locking arms 15 is advantageous inasmuch as by opening, i.e. divaricating in relation to one another and/or with respect to the box body, they tend to rotate according to an axis that is perpendicular to the longitudinal axis A of the box body, generating a thrust against inner surfaces of the housing seat, directed both longitudinally and transversely to the longitudinal axis of the box body 10.

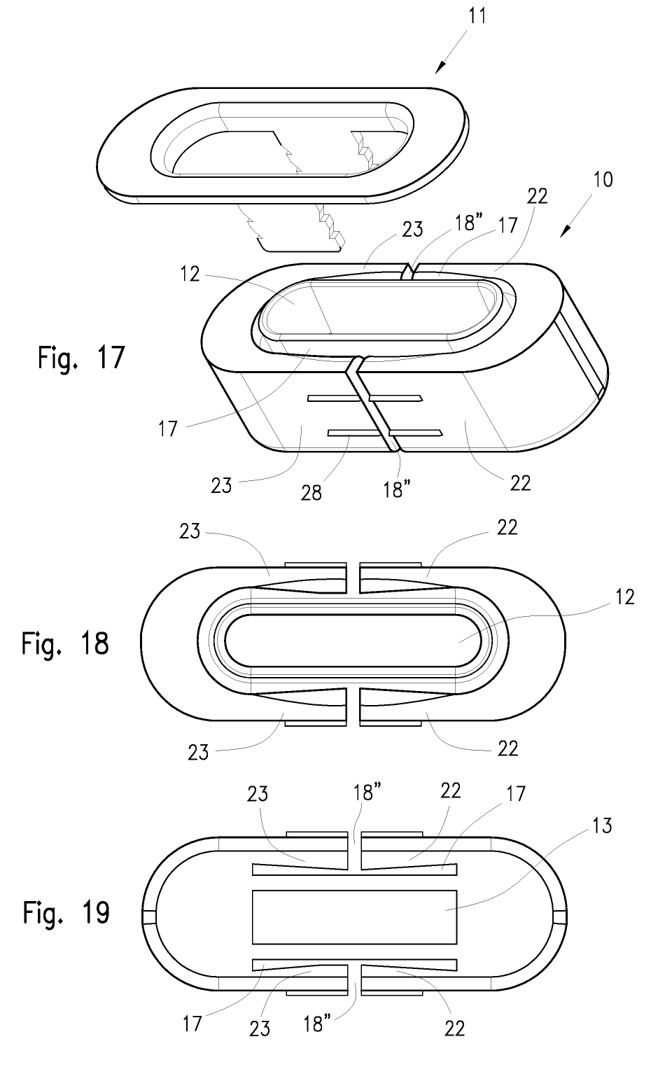

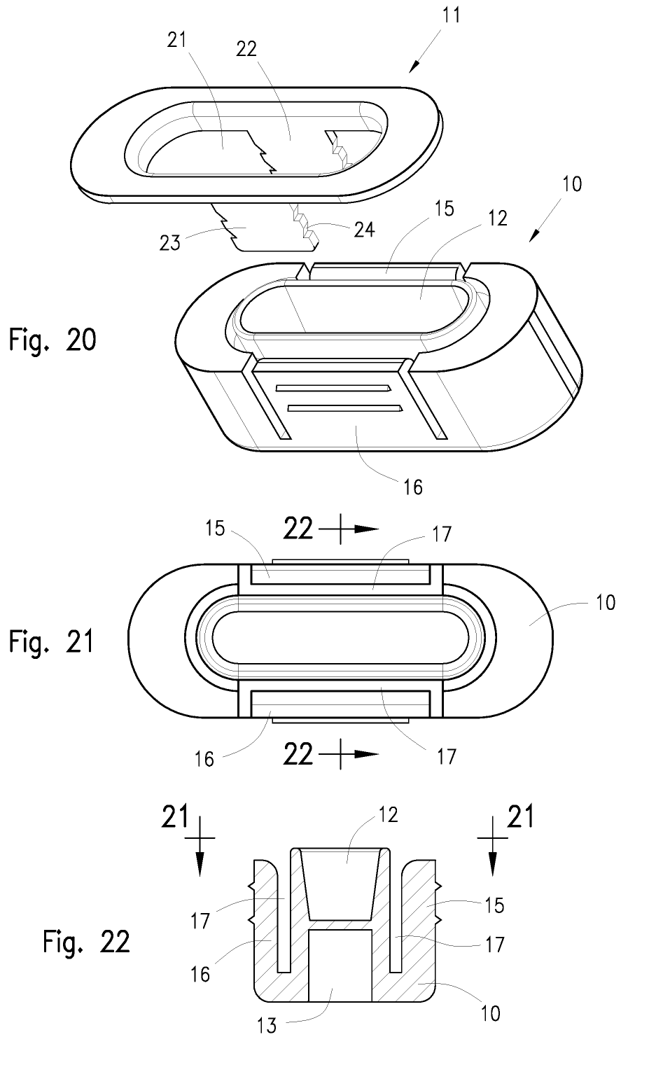

The general principle remaining valid that distinguishes the strike device for locks according to the present invention, other solutions are possible, some of which are shown merely by way of example in FIGS. 17-19, respectively in FIGS. 20-22; for both solutions, again the same reference numbers have been used as in the preceding embodiments to indicate similar or equivalent parts.

The solution of FIGS. 17-19 again comprises, in combination, a box body 10 and a face plate 11 provided with hooking or press-fitting means for press-fitting the box body 10 in its own housing seat of the frame of a door or another wooden support element, consisting of elastically yieldable locking arms 15, 16 of the box body 10, and of rear legs or opening members 22, 23 of the face plate 11, configured for being press-fitted into corresponding slits 17 for laterally flexing and opening the locking arms.

The solution of FIGS. 17-19 differs from the preceding cases inasmuch as now the locking arms 15, 16 are positioned on one or both sides of the body 10, and have a substantially flat or anyway shaped configuration, that extends parallel to the longitudinal axis A of the box body 10. The wedge-shape of the slits 17 that converges on the linear slit 18″, at the centre of the two sides, in combination with a flat conformation of the rear legs 22, 23 as in the preceding embodiments, cause a simultaneous divarication and flexure and a rotation outwards of the two locking arms 15, 16 on each side of the body 10, according to a rotation axis that is orthogonal to the longitudinal axis of the box body 10, at the zone of smaller section. Alternatively to the only rear leg 22, 23 placed centrally on each side along the face plate 11, it is possible to provide on one or on each long side of the face plate 11 two separate rear legs, each acting on a respective locking arm 15, 16. Further, with 28 in this case longitudinal ribs on the outer surfaces of the locking arms 15, 16 have been indicated; for all the rest, the strike device for locks of FIGS. 17-19 can be again fixed in a housing seat, simply by pressing the arms 15, 16 against an inner surface of the housing seat, in the total absence of any fixing screw, again compensating possible machining or processing tolerances of the housing seat.

FIGS. 20-22 show a fifth solution that in certain aspects is comparable to that of FIGS. 17-19; again the same reference numbers have been used as in the previous embodiments to indicate similar or equivalent parts.

The strike device for locks of FIGS. 20-22 comprises again a box body 10 provided with locking arms 15, 16 and a face plate 11 provided with rear legs 22, 23, that are suitable for being forced or press-fitted into corresponding slits 17 to divaricate and flex laterally the locking arms 15, 16, as disclosed previously.

Whereas in the preceding cases the locking arms 15, 16 were opened or flexed elastically outwards with a rotation movement according to a rotation axis that is orthogonal to the longitudinal axis A of the box body 10, or according to a parallel plane of the face plate 11, in the case of FIGS. 20-22 the slits 17 were configured differently so that the locking arms 15, 16 are opened by rotating according to an axis parallel to the longitudinal axis A of the box body 10, or an axis lying on a plane parallel to the face plate 11. In the case of FIGS. 20-22 only one locking arm 15, 16 on each side of the box body 10 has been shown, nevertheless, it is possible to provide for the formation of one or more locking arms on one or on each side of the body 10; for all the rest the strike device of FIGS. 20-22 has the same general characteristics as the previous embodiments.

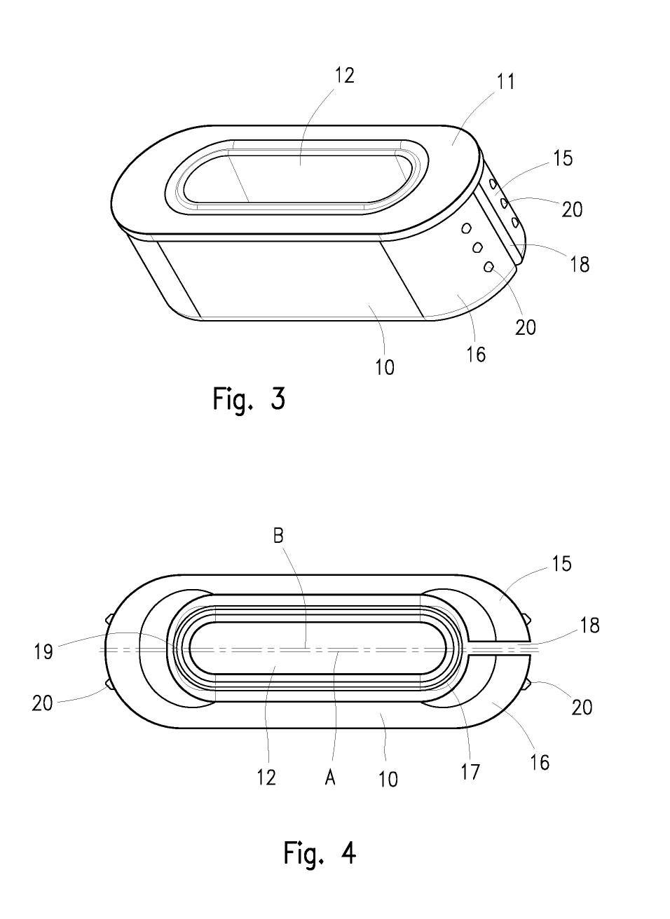

Now with reference to the plan view of FIG. 3, for all the embodiments shown it is possible to provide a laterally offset arrangement of the front cavity 12 of use of the latch or bolt of a lock, with respect to the longitudinal axis A of symmetry of the body 10; in fact, in FIG. 3, with A the longitudinal axis of symmetry of the box body 10 has been indicated, whereas with B the longitudinal axis of symmetry of the front cavity 12 of the body 10 has been indicated. As clearly shown, the axis of symmetry B of the cavity 12 is offset laterally with respect to the longitudinal axis A of symmetry of the body 10, by a small amount, for example by slightly more or less than 1 millimetre. In this manner it is possible to compensate possible misalignments of the front cavity 12 of the box body 10 with respect to the latch or bolt of a lock, simply by rotating the box body 10 by 1800 according to a central rotation axis, orthogonal to the axis A, at the moment of insertion thereof into the housing seat.

From what has been said and shown in the various embodiments of the attached drawings, it is clear that a strike device has been provided for a lock with conventional latch or bolt or of magnetic type, comprising in combination: a box body provided with flexible locking arms, and a face plate provided with rear divaricating legs or members that are variously configured and positioned that are suitable for being press-fitted into corresponding slits of the box body to divaricate or flex laterally the locking arms, anchoring firmly in this manner the box body 10 in a housing seat of a frame of a door, or another wooden support element; in this manner the use of normal fixing screws is eliminated totally, an extreme constructional simplification is obtained of the entire strike device, and extreme ease of application is achieved.

The particular laterally offset arrangement of the front cavity of the box body also enables possible misalignments with the bolt or the latch of the lock to be compensated easily.

1-22. (canceled)

22. A screwless strike device for a lock, comprising:
a) an elongated box-shaped body having a peripheral wall and a frontal cavity, extending according to a longitudinal axis and configured to engage a latch or a bolt of the lock;
b) a face plate conforming to the box body; and
c) a member for fixing the box body in a housing seat of a door frame or support member;
wherein the box body includes one or more elastically yieldable locking arms at least at one end or side of the box body in a spaced apart condition from a respective shoulder surface of the peripheral wall of the box body, and wherein the face plate includes at least one rear pushing member configured to be press-fitted between a locking arm and a respective shoulder surface of the box body to divaricate and press the locking arm against an inner surface of the housing seat for the same box body.

23. The screwless strike device for a lock according to claim 22, wherein the box body comprises at least one locking arm at least at one end or one side of the box body.

24. The screwless strike device for a lock according to claim 22, wherein the box body comprises at least one locking arm at each end, in which the locking arm at one end is oriented in an opposite direction with respect to the locking arm at the other end of the box body.

25. The screwless strike device for a lock according to claim 22, wherein the box body comprises first and second locking arms mutually spaced apart on at least one end.

26. The screwless strike device for a lock according to claim 25, wherein the box body comprises a first and a second locking arm mutually spaced apart at each end in which the locking arms at an end are oriented in an opposite direction with respect to the direction of the locking arms at the other end of the box body.

27. The screwless strike device for a lock according to claim 22, wherein both sides of the locking arm or of each of the locking arms and a respective shoulder surface of the box body are configured with arch-shaped surfaces.

28. The screwless strike device for a lock according to claim 22, wherein each locking arm extends in the direction of the longitudinal axis of the box body.

29. The screwless strike device for a lock according to claim 28, wherein each locking arm is movable apart by rotation about an axis orthogonal to the longitudinal axis of the box body.

30. The screwless strike device according to claim 23, wherein the box body comprises at least one side locking arm which extends parallel to the longitudinal axis on at least one side of the box body.

31. The screwless strike device for a lock according to claim 30, wherein the arm or each side locking arm is movable apart by rotation according to an axis orthogonal to the longitudinal axis of the box body.

32. The screwless strike device according to claim 30, wherein the arm or each side locking arm is movable apart by rotation about an axis parallel to the longitudinal axis of the box body.

33. The screwless strike device for a lock according to claim 31, wherein the box body comprises first and second side locking arms longitudinally spaced apart on at least on side.

34. The screwless strike device for a lock according to claim 22, wherein each locking arm is configured with a hooking arrangement for engaging an inner surface of the housing seat for the box body.

35. The screwless strike device for a lock according to claim 34, wherein the hooking arrangement of the locking arms comprises protrusions, ribs, or toothing.

36. The screwless strike device for a lock according to claim 22, wherein the frontal cavity for engaging the latch or bolt of the lock is configured with a longitudinal axis of symmetry that is parallel to and spaced apart on a side of the longitudinal axis of the box body.

37. The screwless strike device for a magnetic lock according to claim 22, wherein the box body comprises a rear cavity for housing a permanent magnet.

38. The screwless strike device for a lock according to claim 22, wherein the face plate comprises rear pushing members configured to move apart the locking arms with respect to the box body.

39. The screwless strike device for a lock according to claim 22, wherein each divaricating push member for the locking arms is configured as a tile shaped rear leg.

40. The screwless strike device for a lock according to claim 39, wherein each tile shaped rear leg comprises a hooking arrangement for engagement with the box body.

41. The screwless strike device for a lock according to claim 40, wherein the hooking arrangement of each rear leg is configured to engage by interference a corresponding shoulder surface of the peripheral wall of the box body.

42. The screwless strike device for a lock according to claim 39, wherein the leg or each rear leg of the face plate, the arm or each locking arm and the peripheral wall of the box body are provided with corresponding contact surfaces configured to open outwardly and push the arm or each locking arm against an inner surface of the housing seat for the box body.
